(19) United States
(12) Patent Application Publication
(10) Pub. No.: US 2004/0261097 A1
(43) Pub. Date: Dec. 23, 2004

(54) System and method for regulating device use among multiple users

(76) Inventor: Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/464,225

(22) Filed: Jun. 18, 2003

(51) Int. Cl. H04N 7/16

(52) U.S. Cl. 725/29; 725/25; 725/6

(57) ABSTRACT

The present invention provides a system and method for regulating the viewing of a device among multiple users. Briefly described, one embodiment comprises assigning at least one programming time period block to at least one user, each of the programming time period blocks defining a unique period of time that the user is uniquely authorized to select programming on the device, receiving an identity signal from the user, determining if the identity signal corresponds to an identity of an authorized user who is currently authorized to select programming on the device, enabling selection of programming by the user when the identity signal corresponds to the identity of the authorized user, and disabling selection of programming by the user when the identity signal does not correspond to the identity of the authorized user.

### TECHNICAL FIELD

The present invention is generally related to regulating device use and, more particularly, is related to a system and method for regulating the selection of programming of a device, such as a television, among multiple users.

### BACKGROUND

It is desirable to control television (TV) viewing of children or other selected individuals, particularly by limiting the programs viewed (regulation of viewing content), the viewing times, and/or the total amount of viewing time. Thus, a variety of TV viewing controllers allow the parent (or authoritative person) to control viewing via a parental control unit.

One example of a TV parental control unit for limiting viewing by children is configured to block selected programs from viewing (in the absence of the parent's security code). A program is blocked by specifying the time of program start, program length and channel. Another example compares a program identifier with preselected program identifiers such that when the program identifier of the current program matches one of the preselected program identifiers, the viewing of the current program is blocked. Another example selectively blocks programs based upon a program rating provided with programs. Accordingly, such above-described control devices operate on a viewing exception basis wherein the authoritative person, such as the parent, specifies programs that cannot be viewed. That is, the authoritative person specifies, by channel, by time of day, by period, by program identifier, by program rating or the like, which programs that cannot be viewed on the TV when the control unit is operating in a controlling mode.

In contrast, another type of a parental control unit is configured to operate on a viewing permission basis. Thus, the authoritative person specifies programs that can be viewed and/or times of viewing.

Another example of a TV viewing parental control unit for limiting viewing by children is configured to permit the parent to enter a viewing “allowance” (time) for each child. Each child is provided with their own individual password which they use to enable viewing. The password is entered by pushing one to four colored buttons. The password is predefined by the parent. When viewing is enabled, the system decrements the child's remaining viewing time. When the child's viewing time allotment is exhausted, viewing is disabled. In U.S. Pat. No. 5,142,358 to Jason, the child may perform an activity which results in an increase in the allowance time as a reward for accomplishment of a task (earn-per-view). In U.S. Pat. No. 5,060,079 to Rufus-Issacs, the allowance is stored on a magnetic card in possession of the child. As time is used, the remaining time allotment stored on the magnetic card is updated, thereby allowing the child to use the remaining allowance time for later viewing.

However, none of the above-described TV viewing parental control units regulate viewing among multiple parties, such as two or more children. For example, on Saturday morning, when the parent(s) wants to sleep-in and the children are awake early in the morning watching cartoons, disruptive arguments may erupt as the children argue over and compete for program viewing. None of the above-described TV viewing parental control units are capable of fairly allocating TV viewing time among two or more children who want to watch different programs at the same time.

### SUMMARY

One embodiment of the present invention provides a system and method for regulating the use of a device among multiple users. Briefly described, one embodiment is a method comprising assigning at least one programming time period block to at least one user, each of the programming time period blocks defining a unique period of time that the user is authorized to select programming on the device, receiving an identity signal from the user, determining if the identity signal corresponds to an identity of an authorized user who is currently authorized to select programming on the device, enabling selection of programming by the user when the identity signal corresponds to the identity of the authorized user, and disabling selection of programming by the user when the identity signal does not correspond to the identity of the authorized user.

Another embodiment comprises a programming schedule that specifies at least one programming time period block for each of a plurality of users, each of the programming time period blocks defining a unique period of time that one user is authorized to select programming on the device, a user interface configured to receive an identity signal from the one user, and a processor configured to determine if the identity signal corresponds to an identity of an authorized user who is currently authorized to select programming of the device and further configured to enable selection of programming by the user only when the identity signal corresponds to the identity of the authorized user.

### BRIEF DESCRIPTION OF THE DRAWINGS

The invention can be better understood with reference to the following drawings. The elements of the drawings are not necessarily to scale relative to each other, emphasis instead being placed upon clearly illustrating exemplary embodiments of the invention.

FIG. 1 is a block diagram illustrating one embodiment of a program regulator system in accordance with the present invention.

FIG. 2 is a block diagram illustrating a program selection menu displayed by an embodiment of a program regulator system.

FIGS. 3A-F are block diagrams illustrating embodiments of the viewer interface configured to verify that the viewer entering program selections is the viewer currently authorized to select programs.

FIG. 4 is a block diagram illustrating another embodiment of a program regulator system in accordance with the present invention.

FIG. 5 is a block diagram illustrating another embodiment of a program regulator system in accordance with the present invention.

FIG. 6 is a flowchart illustrating an embodiment of a process, according to the present invention, for regulating program selection among two or more viewers.

### DETAILED DESCRIPTION

One embodiment of the present invention regulates the use of electronic devices among multiple users. For convenience, embodiments of the present invention are described and illustrated as regulating programming of a television (TV). Other embodiments of a regulator according to the present invention are configured to regulate playing of, viewing of, and/or listening to other devices, such as a personal computer (PC), an electronic game player, a radio or the like. In embodiments having only audio program signals, such as a radio, the present invention applies to a plurality of listeners.

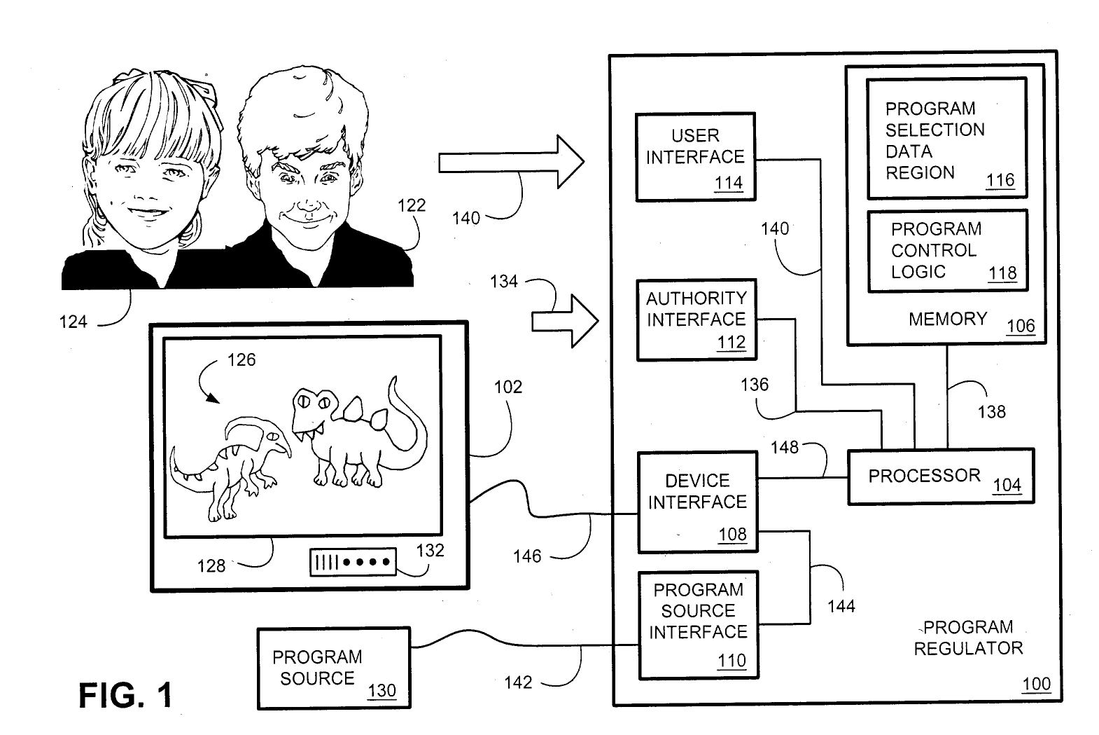

FIG. 1 is a block diagram illustrating one embodiment of a program regulator in accordance with the present invention. Program regulator 100 comprises at least a processor 104, a memory 106, a device interface 108, a program source interface 110, an authority interface 112 and a user interface 114. Memory 106 further comprises a program selection data region 116 and program control logic 118.

For convenience, FIG. 1 illustrates two children, a boy 122 and a girl 124 watching a cartoon 126 on display 128 residing in TV 102. The present invention may be configured by the authoritative person to regulate programming among any number of viewers or users. Accordingly, one of the parents is the presumed authoritative person who determines the viewing privileges of the boy 122 and the girl 124. However, the present invention is not limited to regulating programming among a plurality of children in the home. The present invention is applicable in other environments. For example, TV programming may be regulated in an institution such as a prison or hospital where it is desirable to regulate programming among a plurality of individuals using a shared device. Or, the present invention may be configured to control a portable TV, PC, electronic game player, radio or the like. Or, the present invention may be configured to regulate programming of a device residing in a vehicle, hotel room or other location.

Program regulator 100 is disposed between the program source 130 and TV 102. As described herein, the users are allocated predefined periods of time for selecting a program of their choice. The allocated periods of time assigned to the users are specified in a predefined order that is understood by the users. Thus, each user understands when it is their “turn” to select programming. The program regulator 100 permits only the user currently authorized to select programs (has the current “turn”) to select the program that is displayed on display 128.

Accordingly, one embodiment of the present invention is configured to override the TV controllers when the program regulator 100 is enabled. Thus, the TV controls 132 are not able to control program selection. One embodiment is configured to operate in conjunction with TV 102 much like a remote video source device, such as a video cassette recorder (VCR) or the like. The TV 102 is set to a predefined channel so that program input, provided by the remote program source device, are received and displayed on display 128. Similarly, this embodiment controls selection of the program source to the TV 102.

Only the user currently authorized is permitted to select programs. Accordingly, other users must wait for their “turn” to select programming.

The program regulator 100 is configured to receive instructions from the authoritative person, such as the parent, via the authority interface 112. The instructions, generally indicated by arrow 134, define at least the time that the program regulator 100 is enabled and the periods of time that each of the plurality of users are defined to be the user currently authorized to select programs. The instructions are communicated to processor 104, via connection 136. Processor 104 is configured to store information corresponding to the instructions into the program selection data region 116 of memory 106, via connection 138. Various embodiments of the authority interface 112 are described herein.

When a user who is not the user currently authorized to select programs attempts to select programming, the attempt to select programming is defeated in any number of manners. One embodiment ignores the commands such that the current programming is not changed. Another embodiment controls power of device such that the device is turned off, thereby acting as a restrictive measure. Other embodiments physically sever or open the communication path between the program source 130 and the device, scramble the incoming program signal, electronically block the incoming program signal, substitute another signal such as a warning signal, an error signal or other suitable predefined signal, or change the current programming to a predefined default channel or an empty channel. Accordingly, a user who is not the authorized user who is currently authorized to select programs is prevented from selecting programming by embodiments of the present invention.

The user currently authorized to select programs provides instructions, generally indicated by arrow 140, that cause a desired program to be selected. The instructions are communicated to processor 104, via connection 140. The instructions further comprise identity information. Thus, the user providing the program selection information must prove, or provide, information corresponding to his or her identity such that the program regulator 100 understands that the program selection information is being provided by the user currently authorized to select programs. Thus, processor 104 is configured to compare the identity of the user providing programming instructions with the name (or other suitable identifier) of the user currently authorized to select programs. Programming instructions are implemented only when the identity of the user providing programming instructions corresponds to the user currently authorized to select programs.

Signals from the program source 130, received via connection 142, are relayed to the device interface 108, via connection 144, and are communicated to TV 102, via connection 146. Processor 104 provides suitable control signals to device interface 108, in one embodiment, via connection 148. Accordingly, when programming instructions are received from the currently authorized user to select programs, the requested programming is displayed on display 128 (when the current program comprises video information).

Program source 130 may be comprised of any suitable source of video and/or audio information. The video and/or audio information is defined herein as a program for convenience. Non-limiting examples of a program source 130 include video and/or audio signals from an antennae, cable system, satellite system, VCR, digital video device (DVD), compact disc (CD) device, Internet access system, PC, radio, electronic game player, or the like. Accordingly, in the embodiment illustrated in FIG. 1, the video and/or audio information is received by an embodiment of the program regulator 100 via connection 142.

For convenience, connections 142 and 146 are illustrated as hardwire connections. Connections 142 and 146 may be implemented with other suitable media, such as infrared, optical, wireless or the like without departing from the present invention. Furthermore, connections 136, 138, 140 and 148 are illustrated as hardwire connections to processor 104. In other embodiments, one or more of these connections 136, 138, 140 and 148 may be replaced with other suitable media, such as a bus or the like, and/or may be coupled via one or more other intermediary components without departing from the present invention.

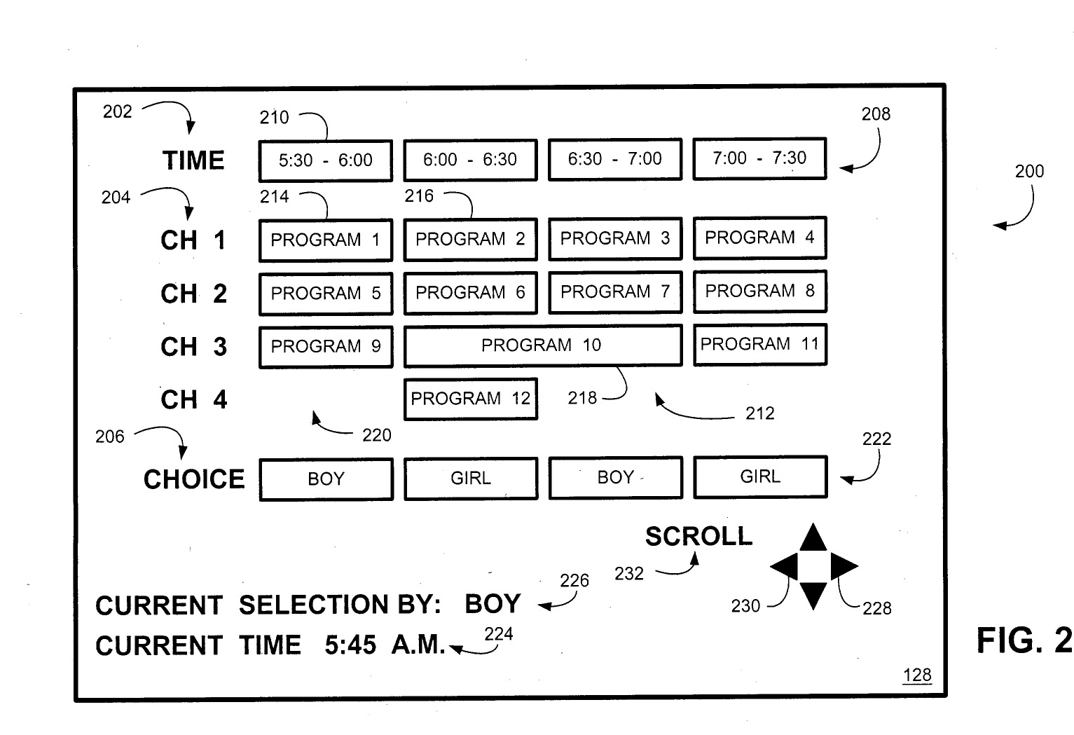

FIG. 2 is a block diagram illustrating an exemplary program selection menu displayed by an embodiment of the program regulator system. The exemplary program selection menu 200 in one embodiment is displayed on display 128 (FIG. 1) so that the program selection menu 200 is easy to view and understand. Alternatively, program selection menu 200 may be displayed on a display incorporated onto the program regulator 100 (FIG. 1), or other embodiments described herein.

Program selection menu 200 comprises a time row 202, a plurality of channel rows 204 and a choice row 206. The time row 202 conveniently divides a predefined future time-period into time-period blocks 208 that correspond to programming times. For example, the time block 210 illustrated on time row 202 corresponds to a time-period beginning at 5:30 and ending at 6:00. Similarly, the other time blocks correspond to the time-periods of 6:00 to 6:30, 6:30 to 7:00 and 7:00 to 7:30. Thus, four half-hour time-periods are displayed. The first time-period block 210 corresponds to the present time. The next three time-period blocks sequentially correspond to future time-periods. Any convenient number of time-period blocks 208 may be defined and displayed on the programs selection menu 200.

In the example of two children 122 and 124 (FIG. 1) viewing TV 102 on Saturday morning, the time-periods are readily understood to be morning (a.m.) times. Text may be added identifying the time-periods, such as the “p.m.” or “a.m.” designations, to further clarify times of its respective time-period block. Alternatively, the time-period blocks 208 may be labeled using any suitable label. Furthermore, color coding may be included as part of the label (colored background and/or colored text) to indicate which user is currently authorized to select programs, as described below.

Furthermore, in an embodiment that monitors and/or limits total viewing time, the number of time-periods corresponding to the remaining total allowed viewing time for the users may be displayed by limiting the number of displayed time blocks 208. Thus, the users would understand the remaining viewing time. For example, if in FIG. 2 the total remaining time was such that viewing is scheduled to end at 7:30 a.m., only the four time-period blocks illustrated on the program selection menu 200 would be displayed. Thus, users would understand that total viewing time is limited to the completion of the current half-hour time-period, plus three more half-hour time-periods. If the remaining time was less, then fewer time-period blocks would be displayed.

Four channel rows 204 are displayed on the program selection menu 200 for convenience. Each channel row 204 is labeled with the appropriate channel identification number. Thus, the user understands that channels 1, 2, 3 and 4 are selectable by the current authorized user to select programs. Each channel row further comprises a plurality of program blocks 212 that contain information identifying a selectable program. For convenience, the first program block 214 on channel 1 is labeled as “program 1.” However, if a particular show of interest is scheduled on channel 1 from 5:30 to 6:00, the labeling of program block 214 would be configured to impart information, such as the title of the program, so that the user understands that this particular show is scheduled for that time-period.

The second program block 216 indicates that a program corresponding to the label “program 2” is scheduled on channel 1 between 6:00 and 6:30. Likewise, each other program block comprises a suitable label indicating the nature of the program that is scheduled to be shown on its corresponding channel and time period.

Furthermore, the length of time that a program is scheduled for may be indicated by the length of a program block. For example, but not limited to, the user understands that program 10 on channel 3 is scheduled to start at 6:00 and is scheduled to end at 7:00 because the program block 218 spans the 6:00 to 6:30 time-period and the 6:30 to 7:00 time-period.

Also, blocked programs are indicated by the absence of displayed program blocks. For example, a blank region 220 corresponding to channel 4 during the 5:30 to 6:00 time-period has been blocked by the authoritative person when programming constraints are initially provided. Thus, the user understands that this program may not be selected. Furthermore, entire channels may be blocked. Such blocked channels are simply not shown on the program selection menu 200. For example, channel 5 may include adult content that the authoritative person (the parent) has determined is not suitable for viewing by the children 122, 124 (FIG. 1). Thus, channel 5 is not displayed. In an alternative embodiment, blocked programs and/or blocked channels are identified with suitable text or a suitable symbol. For example, a blocked program may be shaded or shown as a solid color, such as black or red, to indicate blocking.

The choice row 206 (labeled with the word “CHOICE”) indicates which user is designated as the currently authorized user who is authorized to select programs. Thus, users understand that the user identified in the choice boxes 222 gets to select the currently viewed program. Thus, for the viewing periods corresponding to 5:30 to 6:00 and to 6:30 to 7:00, the label “BOY” indicates that the boy 122 is the user having the program selection authority. That is, boy 122 (FIGS. 1, 3 and 4) gets to select programming during the time-periods corresponding to 5:30 to 6:00 and to 6:30 to 7:00. The girl 124 (FIGS. 1, 3 and 4) is not permitted to select programming. The boy 122, during his program selection time period, is able to change viewing channels as often as desired.

However, the label “GIRL” indicates that the girl 124 has program selection authority for the 6:00 to 6:30 and to 7:00 to 7:30 time-periods. The girl 124, during her program selection time period, is able to change viewing channels as often as desired. Accordingly, the boy 122 is not permitted to select programming during the 6:00 to 6:30 or the 7:00 to 7:30 time-periods.

The label “BOY” and the label “GIRL” may be replaced with any suitable label or symbol such that the users understand whose turn it is to select programming according to the present invention. Furthermore, the word “CHOICE” for the choice row 206, the phrase “CH i” for the identification of channels on the channel rows 204, and the word “TIME” for the time row 202 may be replaced with any suitable label or symbol.

In one embodiment, a colored background and/or colored text is utilized on a choice block 222. Thus, if the girl 124 is unable to read and understand the text that identifies her, the color associated with her choice blocks allows her to understand which choice blocks 222 are assigned to her. Furthermore, all or parts of the columns of information, and/or the blocks 208, 212 and/or 222 themselves, may include the same or similar background and/or text coloring, thereby further clarifying to the user that certain time-periods 208 and colored program blocks 212 are associated with that user.

One embodiment comprises a text line 224 that identifies the current time of day. In the exemplary program selection menu 200, the current time of day is illustrated as 5:45 a.m. The current date and day may also be included. Thus, users understand that the current time-period from 5:30 to 6:00 is the time-period assigned to the boy 122, and that because the boy 122 is the currently authorized user who is authorized to select programs, only the boy 122 may select programming in accordance with the present invention, as described herein.

One embodiment comprises an optional text line 226 identifying the user that is the currently authorized user who is authorized to select programs. Here, the boy 122 is identified as the currently authorized user by the label “BOY” (which also corresponds to the label in the choice box that is positioned below the current time box 210). The identifier on text line 226 may be any suitable label identifying the boy 122, such as the boy's name. Similarly, the label used in the choice boxes 222 may be any suitable label identifying the authorized user, such as the viewer's name.

Other relevant information may be indicated with other text lines. For example, the user that is to be the next authorized user may be identified. In embodiments that track the total remaining allocated viewing time for an individual user, and/or a group of users, may include displayed text indicating remaining viewing time.

In embodiments that are not limited by total viewing time, or in embodiments wherein the display 122 is not sufficiently long enough to display all future programming, the scroll buttons 228 and 230 allow a user to change the menu 222 to display hidden time/program/choice blocks. Thus, actuation of the scroll button 228 scrolls the view to the right by one or more time/program/choice blocks so that future, hidden time/program/choice blocks are displayed. Actuation of the scroll button 230 scrolls the view to the left by one or more time/program/choice blocks. An optional text label 232 may be included to clarify the function of the scroll buttons 228 and 230.

In one embodiment, user interface 114 (FIG. 1) or an auxiliary device is used to operate the menu 200. A plurality of buttons and/or actuators allow a cursor to be positioned adjacent to or over items that are selectable. In another embodiment, blocks that are currently selectable are highlighted with a suitable change in brightness and/or change in color. In the above-described illustrative example of FIG. 2, the boy 122 (FIG. 1) is the currently authorized user. Accordingly, upon providing identity information as described below, the boy may select one of the program boxes (program 1, program 5 or program 9), thereby selecting the program that is to be currently viewed. For example, the boy 122 may actuate the user interface 114 or the auxiliary device to highlight program 9, and then actuate the auxiliary device to select program 9. Thus, a signal corresponding Channel 3 is communicated to the TV 102 such that program 5 is displayed.

Furthermore, since the boy 122 is also the authorized user for the programs corresponding to other time-periods, the boy 122 may also make program selections during those other corresponding times. However, the boy 122 is not permitted to make program selections in the times that he is not the authorized user during other time periods.

Similarly, the girl 124 (FIG. 1) may make selections at any time, but only for the periods of time that she has been designated as the currently authorized user. Accordingly, the girl 124 may select for future viewing one of program 2, program 6, program 10 or program 12 for the 6:00-6:30 time-period. Also, the girl 124 may select for future viewing one of program 4, program 8 or program 11 for the 7:00-7:30 time-period.

The positioning of the time blocks 208, channel blocks 204, choice blocks 206, scroll buttons 230 and 238, and various textual messages are illustrated as shown in FIG. 2 for convenience. The above-described information, and other displayed information, may be positioned on the menu 200 in any desirable order and/or orientation in various alternative embodiments of the present invention.

In the illustrative example of FIG. 2, program 10 is illustrated as encompassing two time blocks (6:00-6:30 and 6:30-7:00). The girl 124 (FIG. 1) is the currently authorized user for the time-period from 6:00-6:30. Accordingly, she may select program 10 and view the first half of program 10. During the second time-period 6:30-7:00 that corresponds to the second half of program 10, the boy 122 is the authorized user. Accordingly, he may choose to watch the second half of program 10, or he may choose to select another program (program 3 or program 7). The choice is his.

In one embodiment, if the boy 122 fails to select program 10 or another program, program 10 remains as the displayed program. In another embodiment that tracks and enforces a total aggregate viewing time and/or an individual viewing time, the program 10 would remain on during the second time-period 6:30-7:00 only if viewing time was still available. In yet another embodiment, if the boy fails to select a program at the beginning of the second time-period 6:30-7:00 (or within a predefined time-period), one embodiment allows any user to select programs for the remainder of that time-period.

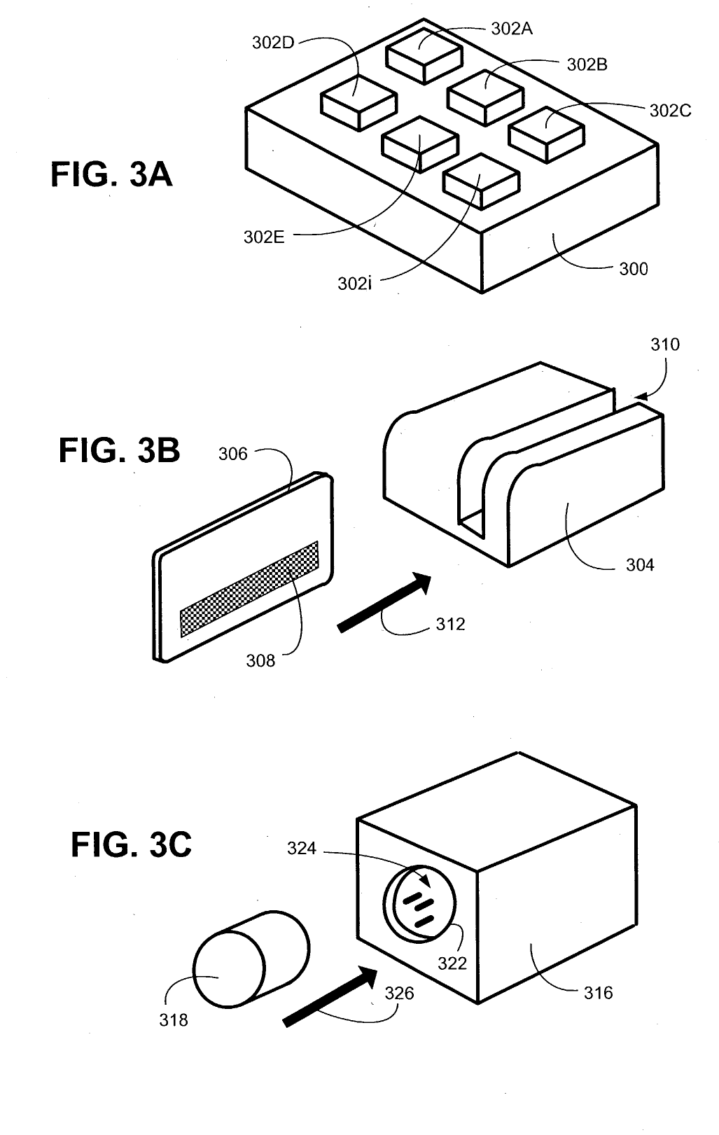

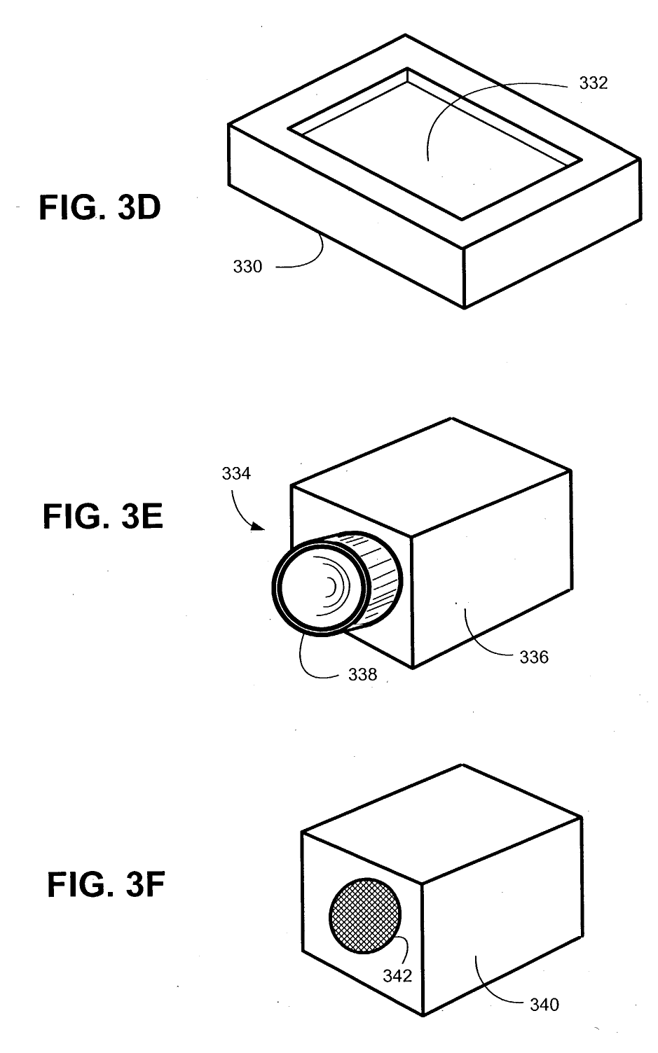

The present invention provides a variety of ways to ensure that only the currently authorized user has the capability to select and/or change programming during their assigned time-period. FIGS. 3A-E are block diagrams illustrating embodiments of the user interface configured to verify that the user entering program selections is the currently authorized user. Authorization devices 300, 304, 316, 330, 334 and 340 (FIGS. 3A-3E) are associated with the user interface 114. Authorization devices 300, 304, 316, 330, 334 and/or 340 may be a component of a user interface 114, or may be stand-alone devices in communication with an embodiment of the program regulator.

FIG. 3A illustrates an embodiment of an authorization device 300 that employs a plurality of buttons 302A through 302i. Before a program selection or change is accepted by the program regulator 100 (FIG. 1), the user attempting to change programming must actuate a predefined number of the buttons 302A-302i in a predefined sequence, referred to as a password, thereby generating an identity signal. A unique password is pre-assigned to each user. The unique password is stored in the program selection data region 116 (FIG. 1). Accordingly, in one embodiment, if the entered password corresponds to the stored password, the user is allowed to proceed with program selection as described above. In another embodiment, if the entered password corresponds to the stored password, the entered program selection is implemented. Thus, each user has their own unique identity information.

Users may be young enough that they are unable to read button labels and/or are unable to remember an alpha-numeric password. Accordingly, one embodiment employs a limited number of colored buttons. For example, but not limited to, one embodiment has three colored buttons. One button is colored green, one is colored yellow and one is colored red. The user is assigned a color-based password that requires actuation of the colored buttons according to the colors of the password. For example, but not limited to, the user may be pre-assigned the password of red-green-red. Thus, the user understands that when the user is the authorized user, the user must actuate the red colored button, then actuate the green colored button, and then actuate the red colored button to generate an identity signal to enter their valid password. This embodiment may employ any number of colored buttons and that passwords may be selected that require a sequential actuation of any number of colored buttons. Furthermore, alpha-numeric text labels may be included on colored buttons for those users that prefer to remember and/or enter alpha-numeric based passwords.

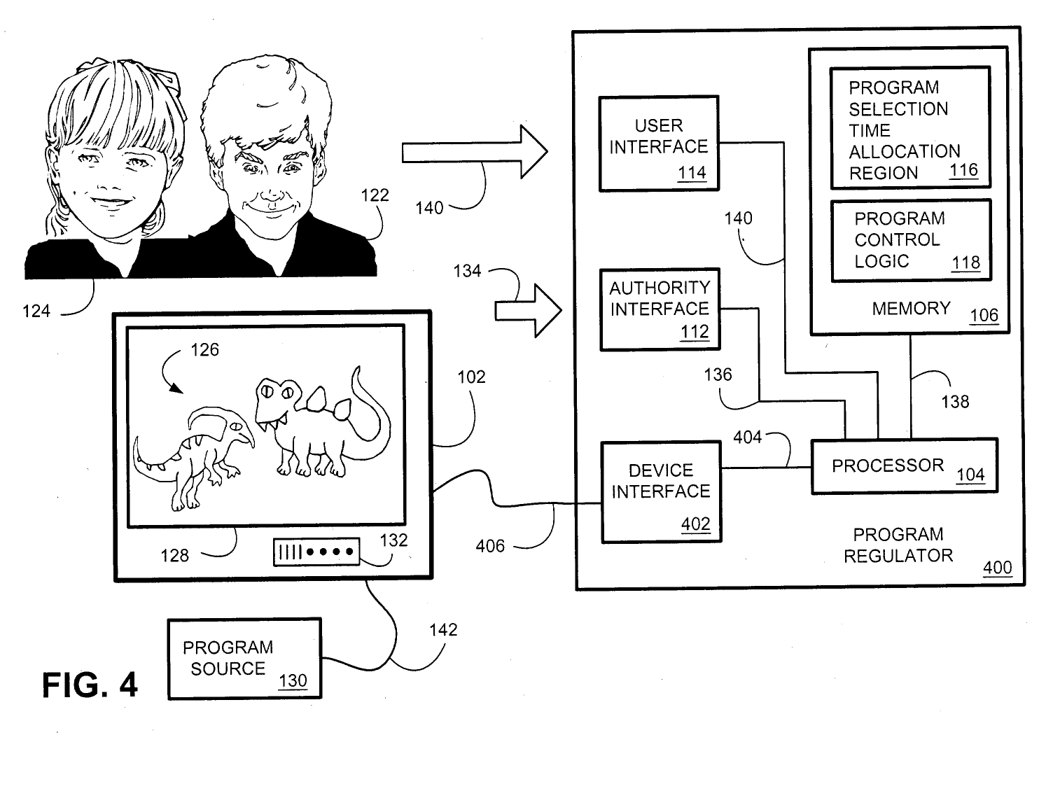

The embodiment of FIG. 3A is particularly suited to implementation as a component of a multi-function device, such as the embodiments of the program regulator 100 (FIG. 1) or program regulator 400 (FIG. 4). Thus, when this embodiment employing buttons and a password is used to verify that the user entering program selections is the currently authorized user is implemented in a remote control unit already having a plurality of predefined buttons, the password may be entered using preexisting buttons to generate an identity signal. Or, if a plurality of colored buttons are to be used, new colored buttons may be added to the multi-function device, and/or existing buttons on the multi-function device may be colored.

FIG. 3B illustrates an embodiment of an authorization device 304 that employs a magnetic card 306. Each user has their own individual magnetic card 306. Before a program selection or change is accepted by the program regulator 100, the user attempting to change programming must “swipe” the magnetic strip 308 on their magnetic card 306 through the slot 310 on the authorization device 304 (as indicated by the direction arrow 312) thereby generating an identity signal. Accordingly, the authorization device 304 is a magnetic card reader.

Prior to viewing, the authoritative party (the parent in the above-described illustrative example), codes the magnetic strip 308 with at least identity information that identifies one user. The authoritative party then gives that card to the identified user. Thus, each user has their own unique identity information.

For convenience, the authorization device 304 is illustrated as a magnetic card reader configured to detect and read information on the magnetic strip 308. This embodiment encompasses any type of magnetic detection device. For example, a magnetic structure configured to generate a magnetic field of a unique characteristic may be embedded in a structure and given to the user. In the case of a small child, the structure may be a brightly shaped plastic toy-like device that is easily recognized and remembered by the child as their own, unique key. When this structure is placed on or near a magnetic sensor device, the unique magnetic field of the magnetic structure is detected, an identity signal is generated, and then interpreted to identify the user, thereby providing the identity information.

FIG. 3C illustrates an embodiment of an authorization device 316 that employs a physical key, referred to herein as dongle 318. Each user has their own individual dongle 318. Before a program selection or change is accepted by the program regulator 100 (FIG. 1), the user attempting to change programming must insert their dongle 318 into a receptacle 322 such that at least one connector 324 is coupled to the dongle 318, as indicated by the direction arrow 326. Dongle 318 comprises internal circuitry that enables program selection in accordance with the present invention. Thus, the presence of an inserted dongle 318 generates an identity signal that identifies the user.

Prior to viewing, the authoritative party (the parent in the above-described simplified example), codes one embodiment of dongle 318 with at least identity information that identifies a user. The authoritative party then gives that dongle to the identified user. Thus, each user has their own unique identity information.

For convenience, the dongle 318 is illustrated as a cylindrical device. This embodiment encompasses any shape of device. For example, in the case of a small child, the dongle 318 may be a brightly shaped plastic toy-like device that is easily recognized and remembered by the child as their own, unique key.

FIG. 3D illustrates an embodiment of an authorization device 330 that employs a fingerprint sensor 332. Since each user has their own individual fingerprint, the user's fingerprint is used to generate an identity signal to identify the user. Before a program selection or change is accepted by the program regulator 100 (FIG. 1), the user attempting to change programming must place their finger onto sensor 332 to generate an identity signal such that the identity of the user is determined.

Prior to using finger print sensor 332, the authoritative party (the parent in the above-described simplified example) has each user place their finger on the sensor 332 and indicates to the authorization device 334 the identity of the user. For example, when the boy 122 initially places his finger on sensor 332, the authoritative person provides information that identifies the boy 122, and the received finger print associated with the boy 122 is saved as a reference fingerprint. Accordingly, the received fingerprint information from the sensor 332 is correlated with the identity of the boy 122. Thereafter, the authorization device 330 can identify the boy 122 by his fingerprint. Thus, each user has their own unique identity information.

FIG. 3E illustrates an embodiment of an authorization device 334 that employs an image capture device 336. Image capture device employs a lens 338. Since each user has their own individual viewable characteristics, an image of the user, or an image of a portion of a user, is used to identify the user. Before a program selection or change is accepted by the program regulator 100 (FIG. 1), the user attempting to change programming must allow their image to be captured to generate an identity signal such that the identity of the user is determined.

One embodiment is used to identify a user by analyzing the user's facial characteristics. Another embodiment is configured to identify a user by analyzing an image of the user's retina or fingerprint.

Prior to viewing, an image of the user, or an image of a portion of a user such as the retina or fingerprint, is captured by the authorization device 334 to generate the identity signal. The authoritative party (the parent in the above-described simplified example) indicates the identity of user associated with the captured image. For example, when an image of the boy 122 is initially captured, the authoritative person provides information that identifies the boy 122, and the received image associated with the boy 122 is saved as a reference image. Accordingly, the captured image received from the image capture device 336 is correlated with the identity of the boy 122. Thereafter, the authorization device 334 can identify the boy 122 by his captured image, his retina, or his fingerprint, depending upon the embodiment. Thus, each user has their own unique identity information.

FIG. 3E illustrates an embodiment of an authorization device 340 that employs a microphone 342. Since each user has their own individual voice patterns, the user's voice is used to identify the user. Before a program selection or change is accepted by the program regulator 100 (FIG. 1), the user attempting to change programming must speak into microphone 342, thereby providing a voice communication, to generate the identity signal such that the identity of the user is determined.

Prior to using the device, the authoritative party (the parent in the above-described simplified example) has each user speak into microphone 342 and indicates to the authorization device 340 the identity of the user. For example, when the boy 122 initially speaks into microphone 342, the authoritative person provides information that identifies the boy 122, and the recorded voice associated with the boy 122 is saved as a reference voice recording. Accordingly, the recorded voice is correlated with the identity of the boy 122. Thereafter, the authorization device 340 can identify the boy 122 by his voice. Thus, each user has their own unique identity information.

The authorization devices 330, 334 and 340 sense biometric information from a user attempting to select programs. The above-described authorization devices 330, 334 and 340 employ processor 104, memory 106 and logic 118 (FIG. 1) to process and analyze the biometric information provided by the user with corresponding biometric information stored in memory. When the received biometric information corresponds to the biometric information of the currently authorized user, program selection is authorized in accordance with the present invention. Any suitable biometric information identification system now known or later developed may be employed by embodiments of the present invention.

FIG. 4 is a block diagram illustrating another embodiment of a program regulator system in accordance with the present invention. Program source 130 is directly providing the program signal to TV 102. Accordingly, program regulator 400 is a remote device and is configured to communicate program selection instructions directly to TV 102, via the device interface 402 and connection 404.

Processor 104 is configured to provide a suitable signal to device interface 402, via connection 406, to specify a program selected by the user currently authorized to select programs. For convenience, connection 406 is illustrated as a hardwire connection. Alternative embodiments may be implemented with other suitable media, such as infrared, optical, wireless or the like without departing from the present invention.

Another embodiment is implemented in a remote device having additional functionality, such as sound control, image display controls, menu display controls and/or control functions associated with other remote devices. In particular, the program regulator 400 may be implemented as an integral component of a remote device controller having a plurality of functionalities, such as a TV remote controller or the like, that provides instructions to the controlled device via infrared, optical, wireless or other suitable signals. Accordingly, when program regulator 400 is implemented as a component of a multi-function remote device, the authority interface 112 and/or the user interface 114 may be implemented via a plurality of control buttons residing on the multi-function remote device.

When a user provides the identity signal that corresponds to the identity of the currently authorized user, program regulator 400 allows communication of programming selections to the TV 102. If the identity signal does not correspond to the identity of the currently authorized user, received programming selections are not communicated to the TV 102 by one embodiment such that the currently selected channel remains displayed. Another embodiment turns off the TV 102. In another embodiment, a programming selection signal is communicated such that the TV 102 displays a predefined channel, such as an empty channel or a default channel. For example, the authoritative person may specify that the default channel be a news channel, public television channel or a weather channel such that the users are likely to choose to turn off the TV 102.

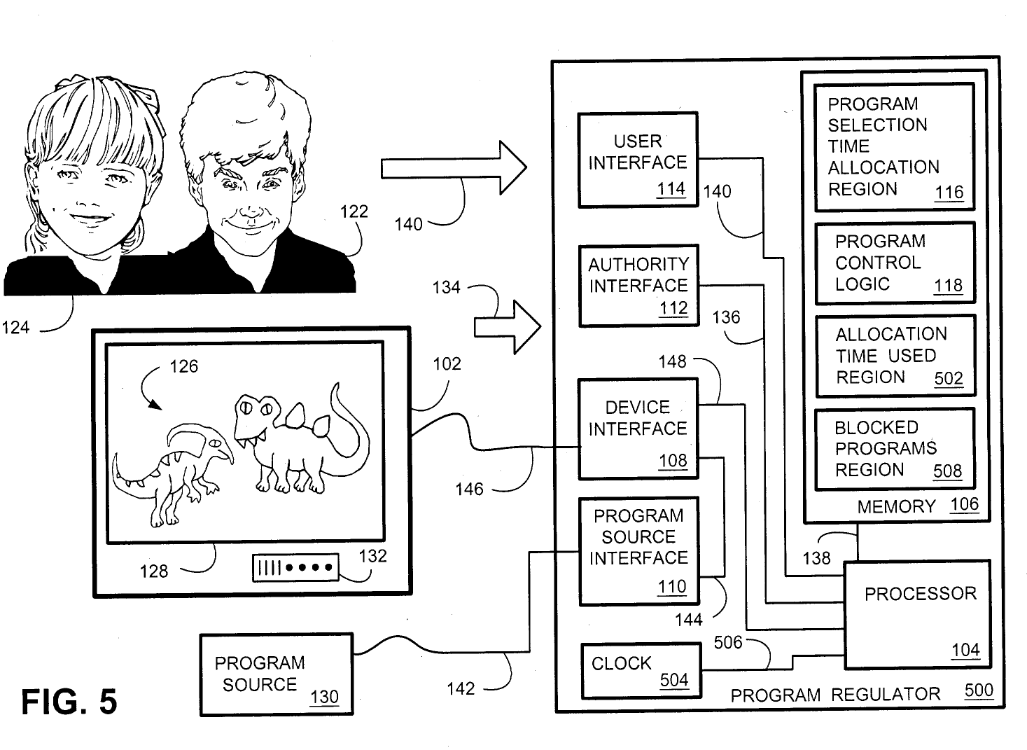

FIG. 5 is a block diagram illustrating another embodiment of a program regulator system in accordance with the present invention. This embodiment includes various exemplary program regulation options. One embodiment of the program regulator 500 comprises logic to monitor total use time by users. Once total viewing time of an individual user, and/or the total use time of a plurality of users, equals a predefined allocation of time specified by the authoritative person, the program regulator 500 blocks further use. The specified predefined allocation times are stored in the allocation time used region 502 of memory 106.

A clock 504 is employed to measure time of viewing, which is communicated to processor 104, via connection 506. The logic correlates the measured viewing time with the viewer currently authorized to select programs, and stores the information in the allocation time used region 502.

Total use time may be allocated by specifying time periods, days and/or dates. For example, the authoritative person may decide to limit total use time to three hours on Saturday morning, independent of the number of users. Once total use time reaches three hours, all programs are blocked, effectively disabling the TV from further use. One embodiment scrambles the incoming source signal from program source 130 to prevent use. Other embodiments generate a substitute signal that is viewed, turns off the TV or changes the programming to an empty channel or a predefined default channel.

The program regulator 500 further comprises logic to block specified programs that are identified in the blocked programs region 508 in memory 106. The authoritative person specifies programs that are to be blocked from viewing. Programs identified for blocking may reside in a list, look-up table or other suitable data base. Thus, if a user who is the currently authorized user tries to select the blocked program, the blocked program is not viewable. Programs may be selected for blocking by specifying program time, program date, program name, program channel or another suitable program identifier. One embodiment scrambles the incoming source signal from program source 130 to prevent viewing of the blocked program. Other embodiments generate a substitute signal that is viewed instead of the blocked channel, turns off the TV or changes the programming to an empty channel or a predefined default channel.

Other program regulation features may also be included in embodiments of the program regulator 500. For example, program channels may be specified for blocking such that all programs on the specified channel are blocked. Furthermore, selected channels may be blocked for selected viewing periods, days and/or dates.

Alternative embodiments comprise either the above-described total viewing time feature or the program blocking feature. Thus, in an embodiment that does not monitor total viewing time, clock 504 and the allocation time used region 502 are omitted.

As described above, embodiments of the present invention are configured by the authoritative person to regulate programming among a plurality of users. The authoritative person predefines a programming schedule that specifies which programming time periods will be assigned to which users. In the illustrative example of FIG. 2, the authoritative person has predefined a programming schedule that specifies that the boy 122 (FIG. 1) is assigned programming privileges during the 5:30-6:00 and the 6:30-7:00 programming time periods. The programming schedule also specifies that the girl 124 is assigned programming privileges during the 6:00-6:30 and the 7:00-7:30 programming time periods.

One embodiment employs a password or other security system to prevent users from modifying the program schedules. A password or the like is advantageous if the authority interface 112 is implemented in a device or component accessible to the users, such as a remote control device. Another embodiment does not require a password or the like. This embodiment is advantageous if the authority interface 112 is implemented in a device or component that is not readily accessible to the users or is too complex for the users to operate.

Another embodiment allows the authoritative person to predefine a plurality of programming schedules for different days. For example, the authoritative person may predefine a second programming schedule that specifies that the girl 124 is assigned programming privileges during the 5:30-6:00 and the 6:30-7:00 programming time periods and that the boy 122 is assigned programming privileges during the 6:00-6:30 and the 7:00-7:30 programming time periods. Thus, if the boy 122 and the girl 124 have different favorite Saturday programs that are shown during the same time period each Saturday morning, they understand that they will take turns every other week in viewing their respective favorite program.

Predefining program features allows the authoritative person to use the present invention as a tool for rewarding good behaviors and for discouraging undesirable behaviors. For example, if the present invention is employed in a prison, a prisoner may be rewarded for good behavior by being allocated programming time periods. As another illustrative example, a trouble causing child can be entirely prohibited from selecting programs as a punitive measure in response to bad behavior from the child.

The authoritative person inputs a programming schedule into embodiments of the present invention via the authority interface 112 (FIGS. 1, 4 and 5), as generally indicated by arrow 134. Any suitable interface device may be employed by embodiment of the present invention.

One embodiment implements the authority interface 112 as a component of a multi-function device such as a remote controller employing a plurality of preexisting buttons. The buttons may be actuated directly in one embodiment to input a program schedule. Alternatively, the buttons can be operated to control a menu configured to receive instructions defining a program schedule.

Other embodiments are implemented as software executed by a processing device, such as a personal computer (PC) or the like. The authoritative person develops a data base defining at least one program schedule in one embodiment. Another embodiment interactively accepts instruction defining a program schedule. Accordingly, authority interface 112 is configured to communicatively couple to the processing device such that program schedules are communicated to the program regulator.

In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

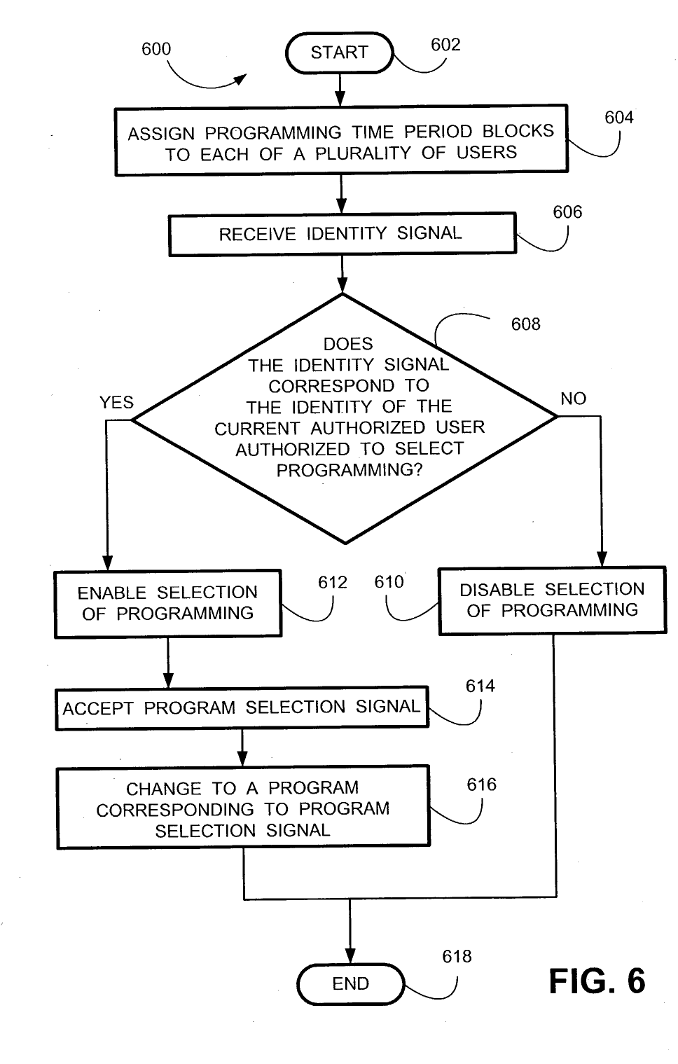

FIG. 6 is a flowchart illustrating an embodiment of a process, according to the present invention, for regulating program selection among two or more users. The flow chart 600 shows the architecture, functionality, and operation of an embodiment for regulating the selection of programming of a device, such as a television, among multiple users, as described above in accordance with the present invention. An alternative embodiment implements the logic of flow chart 600 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 6, or may include additional functions, without departing from the functionality of the present invention. For example, two blocks shown in succession in FIG. 6 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be disclosed herein.

The process starts at block 602. At block 604 at least one programming time period block is assigned to each of a plurality of users, each of the programming time period blocks defining a unique period of time that the corresponding user is authorized to select programming on the device. At block 606 an identity signal is received from one of the users.

At block 608 a determination is made whether the identity signal corresponds to an identity of the current authorized user. If not (the NO condition), the process proceeds to block 610 where selection of programming by the user is disabled. If the identity signal corresponds to the identity of the currently authorized user at block 608 (the YES condition), the process proceeds to block 612 selection of programming by the user is enabled. At block 614 program selection signal from the user is accepted. At block 616 a program is changed to corresponding to the received program selection signal. The process ends at block 618.

The above-described embodiments of a program regulator were described in the context of viewing programs on a TV. Other embodiments are suitable for managing a plurality of users wishing to use a device regulated by the present invention. For example, the device may be an electronic game player or the like. Thus, game players may be assigned times such that one user is currently authorized to select games and/or other attributes of the played game. Or, the present invention may regulate use of a PC and/or Internet access via the PC or another Internet access device. Thus, the user who is the currently authorized user, upon providing the identity signal to the present invention, is allowed to choose programs and/or select Internet sites. Similarly, the present invention may control a radio such that the listener currently authorized to select programs selects which radio station and/or program that is listened to. Other physical devices may be similarly controlled, such as a motorized vehicle. Thus, the user currently authorized to select programs would be allowed to operate the vehicle upon providing the identity signal to the present invention.

Therefore, having thus described the invention, at least the following is claimed:

1. A method for regulating selection of programming of a device, the method comprising:
assigning at least one programming time period block to at least one user, each of the programming time period blocks defining a unique period of time that the user is uniquely authorized to select programming on the device;
receiving an identity signal from the user;
determining if the identity signal corresponds to an identity of an authorized user who is currently authorized to select programming of the device;
enabling selection of programming by the user when the identity signal corresponds to the identity of the authorized user; and
disabling selection of programming by the user when the identity signal does not correspond to the identity of the authorized user.

2. The method of claim 1, further comprising:
monitoring a current time of day to identify a current programming time period block; and
determining the identity of the authorized user assigned to the programming time period block corresponding to the current time of day.

3. The method of claim 1, further comprising:
accepting a program selection signal from the user when the identity signal corresponds to the identity of the authorized user; and
changing to a program corresponding to the received program selection signal.

4. The method of claim 3, further comprising:
comparing the received program selection signal identifying the program with blocked program; and
preventing the device from communicating the program when the program corresponds to the blocked program.

5. The method of claim 1, further comprising:
receiving a first programming schedule that specifies the programming time period blocks assigned to each of a plurality of users for a specified first date; and
receiving a second programming schedule that specifies different programming time period blocks assigned to each of the plurality of users for a specified second date.

6. The method of claim 5, wherein receiving the first programming schedule and the second programming schedule further comprises receiving the schedules from a programming authority.

7. The method of claim 1, further comprising:
monitoring a start time of a current programming time period block for a predefined time period; and
enabling selection of programming by any of a plurality of users when the identity signal is not received within the predefined time period.

8. The method of claim 1, wherein receiving the identity signal further comprises receiving a signal corresponding to a secret unique password entered by the user, the password corresponding to the identity signal.

9. The method of claim 1, wherein receiving the identity signal further comprises receiving a signal from a dongle assigned to the user, the dongle generating the identity signal.

10. The method of claim 1, wherein receiving the identity signal further comprises receiving a signal from a magnetic card assigned to the user, the magnetic card generating the identity signal.

11. The method of claim 1, wherein receiving the identity signal further comprises:
sensing a fingerprint of the user; and
comparing the sensed fingerprint of the user with a reference fingerprint of the user wherein the identity signal is generated when the sensed fingerprint corresponds to the reference fingerprint.

12. The method of claim 1, wherein receiving the identity signal further comprises:
capturing an image of the user; and
comparing the captured image of the user with a reference image of the user wherein the identity signal is generated when the captured image corresponds to the reference image.

13. The method of claim 1, wherein receiving the identity signal further comprises:
capturing an image of a retina of the user; and
comparing the captured image of the retina with a reference retina image wherein the identity signal is generated when the captured image of the retina corresponds to the reference retina image.

14. The method of claim 1, wherein receiving the identity signal further comprises:
recording a voice communication from the user; and
comparing the recorded voice communication of the user with a reference voice communication of the user wherein the identity signal is generated when the recorded voice communication corresponds to the reference voice communication.

15. The method of claim 1, wherein the disabling selection of programming further comprises blocking a programming selection signal.

16. The method of claim 1, wherein the disabling selection of programming further comprises blocking a source signal.

17. The method of claim 1, wherein the disabling selection of programming further comprises substituting a substitute signal for a source signal.

18. The method of claim 1, wherein the disabling selection of programming further comprises scrambling a source signal.

19. The method of claim 1, wherein the disabling selection of programming further comprises changing programming of the device to a predefined program channel.

20. The method of claim 1, wherein the disabling selection of programming further comprises turning off the device.

21. A system for regulating selection of programming of a device, comprising:
a programming schedule that specifies at least one programming time period block for each of a plurality of users, each of the programming time period blocks defining a unique period of time that one user is authorized to select programming of the device;
a user interface configured to receive an identity signal from the one user; and
a processor configured to determine if the identity signal corresponds to an identity of an authorized user who is currently authorized to select programming of the device and further configured to enable selection of programming by the one user only when the identity signal corresponds to the identity of the authorized user.

22. The system of claim 21, further comprising a device interface configured to communicate a program selection signal to the device, wherein the selected program is communicated by the device.

23. The system of claim 21, further comprising a device interface configured to communicate a scrambling signal to the device, wherein a scrambled program is communicated by the device when the identity signal fails to correspond to the identity of the authorized user.

24. The system of claim 21, further comprising a device interface configured to communicate a scrambling signal to the device, wherein the device is turned off when the identity signal fails to correspond to the identity of the authorized user.

25. The system of claim 21, further comprising a device interface configured to communicate a scrambling signal to the device, wherein a predefined default channel is communicated by the device when the identity signal fails to correspond to the identity of the authorized user.

26. The system of claim 21, further comprising a device interface configured to communicate a signal to the device, wherein a blank channel is communicated by the device when the identity signal fails to correspond to the identity of the authorized user.

27. The system of claim 21, wherein the device interface further comprises a plurality of buttons on a multi-function device so that the one user enters a predefined unique password to generate the identity signal.

28. The system of claim 21, further comprising a dongle so that the one user couples the dongle to the device interface to generate the identity signal.

29. The system of claim 21, wherein the device interface further comprises a magnetic card reader configured to receive information from a magnetic card to generate the identity signal.

30. The system of claim 1, wherein the device interface further comprises a fingerprint sensor configured to receive information from a fingerprint of the one user to generate the identity signal.

31. The system of claim 1, wherein the device interface further comprises an image capture device configured to capture an image of the one user to generate the identity signal.

32. The system of claim 1, wherein the device interface further comprises an image capture device configured to capture an image of a retina of the one user to generate the identity signal.

33. The system of claim 1, wherein the device interface further comprises microphone configured to capture a voice communication of the one user to generate the identity signal.

34. The system of claim 21, further comprising an authority interface configured to receive the programming schedule from an authoritative person.

35. The system of claim 21, wherein the device comprises at least one selected from a group consisting of a television, a radio, a personal computer, a digital video device (DVD), a compact disc (CD) device, an Internet access system, a motorized vehicle and an electronic game player.

36. A system for regulating the selection of programming of a device, comprising:
means for receiving a programming schedule, the programming schedule specifying at least one programming time period block to each of a plurality of users, each of the programming time period blocks defining a unique period of time that the corresponding user is authorized to select programming on the device;
means for receiving an identity signal from one user;
means for determining if the identity signal corresponds to an identity of an authorized user who is currently authorized to select programming of the device; and
means for enabling selection of programming by the one user only when the identity signal corresponds to the identity of the authorized user.

37. The system of claim 36, further comprising means for disabling selection of programming when the identity signal does not correspond to the identity of the authorized user.

38. The system of claim 36, further comprising:
means for accepting a program selection signal from the one user when the identity signal corresponds to the identity of the authorized user; and
means for changing to a program corresponding to the received program selection signal.

39. The system of claim 38, further comprising:
means for comparing the received program selection signal identifying the program with at least one blocked program; and
means for preventing the device from communicating the program when the program corresponds to the blocked program.

40. A computer-readable medium having a program for regulating selection of programming of a device, the program comprising logic configured to:
receive a programming schedule, the programming schedule specifying at least one programming time period block to each of a plurality of users, each of the programming time period blocks defining a unique period of time that a one user is authorized to select programming of the device;
receive an identity signal from the one user;
compare the identity signal with an identity of an authorized user who is currently authorized to select programming of the device;
enable selection of programming by the one user when the identity signal corresponds to the identity of the authorized, user; and
disable selection of programming by the one user when the identity signal does not correspond to the identity of the authorized user.
